(19) United States
(12) Patent Application Publication
(10) Pub. No.: US 2025/0342450 A1
(43) Pub. Date: Nov. 6, 2025

(54) SYSTEMS AND METHODS FOR PRODUCT CIRCULARITY

(71) Applicant: Schlumberger Technology Corporation, Sugar Land, TX (US)

(72) Inventor: Denis Heliot, Sugar Land, TX (US)

(21) Appl. No.: 18/654,936

(22) Filed: May 3, 2024

(51) Int. Cl. G06Q 10/30; G06V 10/70

(52) U.S. Cl. CPC G06Q 10/30; G06V 10/70

(57) ABSTRACT

An apparatus for circulating a product includes at least one sensor configured to scan a product and provide data associated with the scanning of the product to at least one processor. The apparatus includes the at least one processor, where the at least one processor is configured to analyze the data and identify at least one of: the product, one or more parts of the product, one or more materials of the product, one or more characteristics of the product, or one or more circularity maps based on the analysis of the data from the at least one sensor.

### BACKGROUND

Traditionally, the majority of products are designed by companies based on what consumers want in terms of functionality and aesthetics, and are produced on the basis of cost. Once those products are sold and leave the premises, the company considered their responsibility for the product as completed. Once the consumer is done with the product, typically the product is disposed of. This model is sometimes referred to as a linear economy model.

Current trends, however, represent a shift towards a circular economy. The circular economy model seeks to minimize environmental impact (e.g., reducing landscape and habitat disruption and limiting biodiversity loss), by reusing and recycling products, to slow down the use of natural resources by reducing waste. Another benefit from the circular economy is a reduction in total annual greenhouse gas emissions.

Circular products are products that operate within a circular economy model. Circular products are designed with different considerations beyond only functionality, aesthetics, and production cost. For example, product design for the circular economy model may consider the circularity of the product at each stage of the product lifetime: the production of the product, the lifetime of the product use, and the end-of-life of the product. As another example, product design for the circular economy aims to create products that are durable, modular, and adaptable, reducing the need to dispose of these products.

Circular products may be designed to have reduced, or eliminated, need for virgin resources. As an illustrative example, a circular product design may consider whether a product can be engraved, rather than placing a label on the product. As another illustrative example, a circular product design may consider whether a product can be designed from a material than can be sourced from an existing resource stream (e.g., a recycled or upcycled material) instead of a virgin resource.

Circular products may be designed to be environmentally friendly throughout their lifetime. For example, circular products may be designed to have replaceable or repairable parts, rather than the need for a completely new product in the event of a break down.

Circular products may be designed with the product end-of-life in mind. For example, circular products may be designed to be recyclable or reusable at the product end-of-life, rather than disposable. The circular economy model may consider product reuse as more desirable than product recycling.

One issue in product circularity is that a user of the product may not have knowledge regarding the circularity of the product. For example, the user may not know what parts or materials the product is composed. Further, the user may not know how to dispose of, reuse, recycle, or otherwise circulate the product, parts of the product, and/or materials of the product. This problem may be exacerbated in the case of products with long lifetimes, in which case the product may change ownership multiple times, and/or the consumer may not have contact, or even be aware of, the original manufacturer, vendor, or designer company of the product. Further, in complex products, it may be particularly difficult for consumers to know what to do with the product at the end of its life. One example is oil and gas field equipment, which may be large, complex, and/or have long lifetimes.

Accordingly, there is a need for systems and methods to improve product circularity.

### SUMMARY

Aspects of the present disclosure provide systems, apparatus, and methods for a product circularity.

In one aspect, an apparatus for circulating a product is provided. The apparatus comprises at least one sensor configured to: scan a product; and provide data associated with the scanning of the product to at least one processor. The apparatus includes the at least one processor configured to: analyze the data; and identify at least one of: the product, one or more parts of the product, one or more materials of the product, one or more characteristics of the product, or one or more circularity maps based on the analysis of the data from the at least one sensor.

In another aspect, a method for circulating a product is provided. The method comprises scanning a product with at least one sensor; providing data associated with the scanning of the product to at least one processor; analyzing the data with the at least one processor; and identifying, with the at least one processor, at least one of: the product, one or more parts of the product, one or more materials of the product, one or more characteristics of the product, or one or more circularity maps based on the analysis of the data from the at least one sensor.

In another aspect, a system for circulating a product is provided. The system comprises a circularity database containing a plurality of associations of products or parts products to circularity maps; a circularity marketplace comprising a plurality of listings for selling products or parts, exchanging products or parts, purchasing products or parts, disposing of products or parts, or circularity services for at least one of: recycling, refurbishing, or recovering materials from products or parts; and a handheld user device, the handheld user device comprising: at least one sensor configured to: scan a product to collect data associated with the product; and provide the data associated with the product to at least one processor; and the at least one processor, wherein the at least one processor is configured to: analyze the data; and identify the product or the one or more parts of the product; a network interface configured to: access the circularity database via a network; identify one or more circularity maps associated with the product or the one or more parts of the product; and return the identified one or more circularity maps to the at least one processor, wherein the at least one processor is further configured to select one or more circularity protocols for the product or the one or more parts of the product based on the one or more circularity maps, and wherein the network interface is further configured to: access the circularity marketplace via a network; and list, in the circularity marketplace, for sell, exchange, disposal, or service at least one of: the product, the one or more parts of the product, or one or more materials of the product based on the selected circularity protocols.

The following description and the appended figures set forth certain features for purposes of illustration.

### BRIEF DESCRIPTION OF DRAWINGS

The appended figures illustrate only exemplary embodiments and are therefore not to be considered limiting of the scope of the disclosure, as the disclosure may admit to other equally effective embodiments.

FIG. 1 depicts an example system for product circularity.

FIG. 2 depicts an example product scanning device for product circularity.

FIG. 3 depicts a flowchart of an example method for product circularity.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Aspects of the present disclosure provide systems, apparatus, and methods for a product circularity.

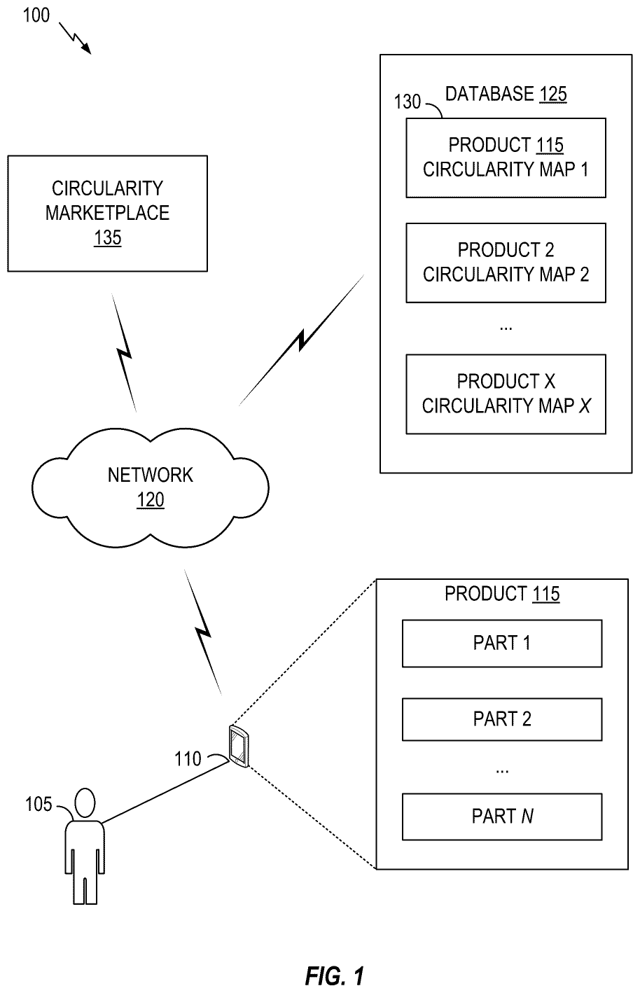

FIG. 1 depicts an example system 100 for product circularity. According to certain aspects, a user 105 of a product 115 in the system 100 may use a user device 110 to obtain product circularity information about the product 115.

The user 105 may be a direct user of the product 115. The user 105 may be a person responsible for product circulation of the product 115. For example, the user 105 could may be a person at a company that owns the product 115, and who is responsible for handling the circulation of product 115, or the user 105 a third party handling the circulation of the product 115. Although the user 105 is shown in FIG. 1, in some aspects, an automated system may perform the circulation of the product 115.

The product 115 may be any commercial product. In some aspects, product 115 may be equipment used in oil and gas production or processing. As shown in FIG. 1, product 115 may be composed of multiple constituent parts, Part 1, Part 2, . . . Part N. Illustrative examples of oil and gas products include downhole tools, wirelines cables used in wireline logging operations to collect data about subsurface formations and provide the data to surface equipment, a printed wiring assembly (PWA) component, a drilling collar or a measurement while drilling (MWD) collar, and other oil and gas equipment or tools.

The product 115 may be associated with circularity information. In some aspects, the circularity information for the product 115 may be stored in a database 125. In some aspects, the database 125 may be accessible by the user device 110 via a network 120. For example, the user device 110 may have a hard-wired connection, a wireless connection, or a combination of hard-wired and wireless connections with the network 120. The network 120 may be the Internet, a wireless wide area network (WWAN), a wireless peer-to-peer network, a local area network (LAN), a wireless LAN (WLAN), a wide area network (WAN), a Wi-Fi network, a wireless personal area network (WPAN), a cloud, or other network. For example, the database 125 may be stored on a server or in the cloud. Although the database 125 is shown in FIG. 1 as accessible to the user device 110 via the network 120, in some aspects the database 125 may be stored directly on the user device 110.

The circularity information for the product 115 may include a product circularity map 130 for the product 115. In some aspects, the circularity map 130 for the product 115 includes circularity information for each of the constituent parts 1, 2, . . . N of the product 115. In some aspects, the circularity map 130 for the product 115 includes information separating the product 115 into the constituent parts 1, 2, . . . N. For each of the parts, the circularity map 130 for the product 115 may include a quantitative description of the content of the parts. For example, the circularity map 130 for the product 115 may include a quantitative description (e.g., an amount, a ratio, or a percentage), for each identified constituent part, of the amount of precious or critical metals (e.g., cobalt, chromium, vanadium, molybdenum, nickel, lead, copper, aluminum, gold, silver, platinum, etc.) that make up the part. In some aspects, where the product 115 includes multiple parts, the circularity information may include instructions for separating the multiple parts from each other (e.g., instructions for disassembling the product into the identified constituent parts). In some aspects, the circularity information includes a listing of tools or equipment needed for executing the circularity instructions.

In some aspects, the circularity information for the product 115 may include, for the product 115, or for each of the constituent parts of the product 115, instructions for one or more circularity processing methods. In some aspects, the circularity information for the product 115 may include, for the product 115, or for each of the constituent parts of the product 115, technical details for the performing the refurbishing, reuse, recycling, and/or disassembly for recovery of the precious or critical metal components.

Refurbishing may involve restoring or renovating the product to extend its lifespan and functionality. Refurbishing products allows the product to be used for a longer period, reducing the need for new replacements. In some cases, a refurbished product may be resold or distributed to other customers. Refurbishing typically utilizes fewer resources compared to manufacturing new products. Thus, refurbishing reduces waste and energy and resource consumption. This aligns with the circular economy's aim to maximize the utility and value of products. In addition, refurbishing can create jobs and stimulate economic growth by supporting industries involved in repair and renovation.

Reuse involves using the product or part again after the product or part has fulfilled its original purpose, instead of discarding the product or part. In some cases, a reused product may be reused by the user. A retailer or distributor may reuse a product by reselling it to another consumer. Reuse can occur at various levels, such as individual consumer reuse, business-to-business reuse, and industrial-scale reuse. Reuse may involve repurposing products or parts. Reuse helps reduce waste and the consumption of energy and new resources.

Recycling may include one or more techniques for recovering and repurposing the precious or critical materials of the product. Recovery of the materials may include dismantling, grinding, melting down, or other recovery techniques, to extract the precious or critical metals that make of the part. These precious or critical metals can then be sold or used to create a new product.

In some aspects, the circularity information for the product 115 may include instructions for shipping the product 115 or part (or one or more components of the part) for refurbishing, reuse, recycling, and/or disassembly for recovery of the precious or critical metal components. For example, the circularity information may include shipping destination details (e.g., company names, addresses, contact information).

As shown in FIG. 1, the database 125 may contain circularity maps for multiple different products (e.g., product 2 circularity map 2, product 3 circularity map 3, . . . , product X circularity map X).

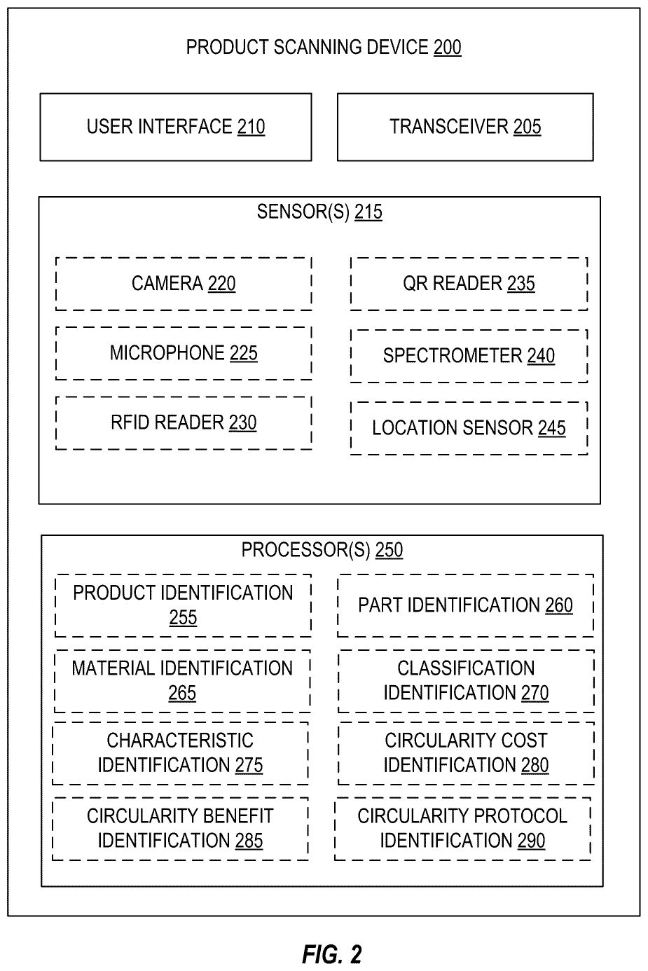

In some aspects, the user 105 may access the circularity map 130 via the user device 110. The user device 110 may be a laptop computer, a smart phone, a tablet, a scanning device, an existing equipment, or another device with product circularity software running thereon. In some aspects, the user device 110 is a new product circularity device. The user device 110 is described in more detail herein with respect to FIG. 2.

In some aspects, the user device 110 is configured to scan the product 115. For example, the user device 110 may be configured with various scanning technologies. In some aspects, the user device 110 is configured to take an image or video of the product 115. In some aspects, the user device 110 is configured to measure one or multiple of shape, color, location, weight, sound, smell, chemistry, spectral measurements, and/or physical measurements of the product 115. In some aspects, the user device 110 is configured to scan one or more markings on the product 115, and/or on the respective parts. For example, the markings may be a label, a radio frequency identifier (RFID) tags, serial number, bar code, text (e.g., indicating a company name, product name, and/or part name), a quick-response (QR) code, a pictogram, an alphanumerical code, or the like. While certain measurements are provided as examples herein, it should be understood that the user device 110 may be configured to perform other types of measurements, such as any measurement done in the oil and gas industry and/or in the medical industry.

In some aspects, the user device 110 is configured to identify the product 115 based on the scan. In some aspects, the user device 110 identifies the product 115 based on checking the circularity map 130 for the product 115 in the database 125 after scanning the product 115. In some aspects, the user device 110 searches the database 125 based on the scanned marking(s) on the product 115. In some aspects, the user device 110 identifies the product 115 based on scanning the product 115 and identifying one or more of the characteristics and/or properties of the product 115. In some aspects, the user device 110 may use a trained machine learning model (or may communicate with a server that runs the model) configured to identify the product 115 based on the one or more of the identified characteristics and/or properties of the product 115.

In some aspects, the user device 110 is configured to identify the respective parts of the product 115 based on the scan. In some aspects, the user device 110 identifies the respective parts of product 115 based on checking the circularity map 130 for the product 115 in the database 125 after scanning the product 115 to identify the product 115. In some aspects, the user device 110 identifies the respective parts of the product 115 based on scanning the product 115 and identifying one or more of the characteristics and/or properties of the parts. In some aspects, the user device 110 may use a trained machine learning model (or may communicate with a server that runs the model) configured to identify the respective parts of the product 115 based on the one or more of the identified characteristics and/or properties of the product 115.

In some aspects, the user device 110 is configured to identify one or more characteristics or properties of the product 115, or of the respective parts of the product 115, based the scan. In some aspects, the user device 110 identifies the one or more characteristics or properties of the product 115 based on checking the circularity map 130 for the product 115 in the database 125 after scanning the product 115 to identify the product 115. In some aspects, the user device 110 identifies the one or more characteristics or properties of the product 115 based on scanning the product 115. In some aspects, the user device 110 directly measures or senses the one or more characteristics or properties of the product 115. In some aspects, the user device 110 may use a trained machine learning model (or may communicate with a server that runs the model) configured to identify the one or more characteristics or properties of the product 115 based on the scanning.

In some aspects, the user device 110 is configured to obtain the circularity information for the product 115, or the respective part, based on the scan. In some aspects, the user device 110 identifies the circularity information for the product 115, or the respective parts of the product 115, based on checking the circularity map 130 for the product 115 in the database 125 after scanning the product 115 to identify the product 115. In some aspects, the user device 110 identifies the circularity information of the product 115, or the respective parts of the product 115, based on scanning the product 115 and identifying one or more of the characteristics and/or properties of the parts. In some aspects, the user device 110 may use a trained machine learning model (or may communicate with a server that runs the model) configured to identify the respective parts of the product 115 based on the one or more of the identified characteristics and/or properties of the product 115.

In some aspects, the user device 110 may automatically obtain the circulation information based on scanning the product 115. In some aspects, the user may input information from the scan to the machine learning and/or to search the database 125 to obtain the circulation information for the product 115.

In some aspects, the user device 110 is configured to classify the identified product 115, or the respective parts of the product 115, into one or more categories. In some aspects, the user device 110 can then identify characteristics associated with the categories from the database 125. In some aspects, the user device 110 may use a trained machine learning model (or may communicate with a server that runs the model) configured to classify the identified product 115, or the respective parts of the product 115, into the one or more categories.

In some aspects, the user device 110 is configured with software, such as an application running on the user device 110, that is configured to analyze the scanning data (e.g., the images, measurements, etc., collected by the scanning). In some aspects, the application uses a machine learning algorithm to match an image captured by the user device 110 to a category, product, or part. In some aspects, based on the identified category, product, or part, the application may provide a recommendation to the user for circulation of the product 115.

In some aspects, the measurements taken and/or the reference database used to analyze the measurements may be based on the use-case. For example, for products used at a maintenance base, a wellsite, a junkyard, a home, etc., the user device 110 may perform different types of scanning or measurements and/or different databases may be used for analyzing the collected data and/or for determining a product circularity recommendation.

In some aspects, the user device 110 estimates a circularity cost, a Carbon footprint benefit, a market value benefit (e.g., a market value for the product, part, or recovered material from the product or part) associated with one or more circularity protocols for the identified product, part, or material of the product or part. The user device 110 may provide the estimated cost(s) and/or benefit(s) to the user. The user device 110, or the user, may use the estimated cost(s) and/or benefit(s) to select a circularity protocol for the product, part, or material.

In some aspects, the database 125 (or a separate database) associates various products, parts, and/or materials with the cost(s) and/or benefit(s) for one or more circularity protocols. For example, the database may associate the various products, parts, and/or materials with a cost (or range of costs), a Carbon footprint (or range of Carbon footprint), and/or a market value (or range of market values) for one or more multiple of refurbishing, reusing, recycling, selling, or recovering the products, parts, and/or materials.

In some aspects, the database 125 (or a separate database) associates the data (e.g., scanning images and/or measurements by the user device 110) with the cost(s) and/or benefit(s) for one or more circularity protocols. For example, the database may associate data values, ranges, or classifications with a cost (or range of costs), a Carbon footprint (or range of Carbon footprint), and/or a market value (or range of market values) for one or more multiple of refurbishing, reusing, recycling, selling, or recovering the products, parts, and/or materials.

In some aspects, the user device 110 may use a trained machine learning model (or may communicate with a server that runs the model) that determines an overall cost and/or benefit associated with the circularity the product 115 based on estimating the respective costs and/or benefits associated with circularity the respective parts and/or materials of the product 115. In some aspects, the machine learning model determines the circularity protocols for each of the parts and/or materials of the product 115 that provides a maximum benefit and/or minimum cost to recommend an overall circularity protocol for the product 115. For example, the user device 110 may provide a recommendation to the user 105 of a subset of parts and/or materials of the product 115 to dispose of, a subset of parts and/or materials of the product 115 to recycle, furbish, and/or reuse, and/or a subset of parts and/or materials of the product 115 to sell.

In some aspects, a circularity marketplace 135 is provided. In some aspects, the circularity marketplace 135 (e.g., a webpage or application) allows the user 105 to buy, sell, exchange, and/or dispose of products, parts, and/or materials for product circularity. In some aspects, prices in the circularity marketplace 135 are set, or recommended, by the machine learning model that estimates that the cost(s) and benefit(s) of the circularity protocols for the products, parts, and materials. In some aspects, users of the circularity marketplace 135 can bid on prices for purchasing items or services in the circularity marketplace 135. In some aspects, the prices in the circularity marketplace 135 may be adjusted based on how long an item has been listed in the circularity marketplace 135 and/or based on demand and/or availability of similar items in the circularity marketplace 135.

In some aspects, the circularity marketplace 135 uses a circularity points system, in which users are awarded circularity points for offering, disposing, recycling, or other circularity products, parts, and/or materials via the circularity marketplace. In such a marketplace, financial transactions may not occur. Instead, users of the circularity marketplace 135 only gain circularity points, which incentives lies in the user tracking their progress based on gaining circularity points. In some aspects, the circularity points are awarded and tracked in addition financial exchanges in the circularity marketplace 135. In some aspects, the circularity points may be exchanged in the circularity marketplace 135 for items or services, in lieu of financial transactions.

According to certain aspects, the user 105 may circularity the product 115 based on the recommendations provided by the user device 110. In some aspects, circulating the product 115 may include circulating the product 115 (or respective part of material of the product 115) via a third party using contact information and/or shipping destination information for circulating each identified part of the product for refurbishing, reuse, recycling, or recovery of the precious or critical metals, based on the based on the circularity information for each of the identified parts. In some aspects, the user 105 may identify tools or equipment, and/or obtain the tools and/or equipment, for disassembling or separating, and/or instructions for how to perform disassembly or separating, of the identified parts (or component materials) of the product based on the based on the circularity information for each of the identified parts. In some aspects, the user 105 may refurbish, reuse, recycle, sell, or recover the precious or critical metals from, each identified part of the product 115 following instructions in the circularity information for each of the identified parts. In some aspects, the user 105 may use the circularity marketplace 135.

In some aspects, the user device 110 may automatically circulate the product 115 via the circularity marketplace 135 in response to scanning the product 115 and analyzing the collected data. In some aspects, the user device 110 may first prompt the user for one or more permissions to circulate the product via the circularity marketplace 135.

FIG. 2 depicts a product scanning device 200 for product circularity. In some aspects, the product scanning device 200 is an example of the user device 110 illustrated in FIG. 1.

As shown, the product scanning device 200 may include a user interface 210. In some aspects, the user interface 210 includes a graphical user interface (GUI) that display to a user (e.g., user 105). In some aspects, the GUI accepts touch screen inputs from the user. In some aspects, the user interface 210 includes one or more input/output (IOs) interfaces that allows one or more I/O devices (e.g., keyboards, displays, mouse devices, pen inputs, microphones, etc.) to connect to the product scanning device 200. The user interface 210 may allow the product scanning device 200 to provide product, part, material, classification, and/or characteristic identification information, circularity information, returned circularity database information, recommend circularity protocols, estimated circularity cost(s) and/or benefit(s) information, and/or one or more requested input prompts, to the user. The user interface 210 may allow the product scanning device 200 to receive inputs from the user. The user interface 210 may allow the user 105 to initiate scanning of the product (e.g., product 115), to interact with the circularity database (e.g., database 125), and/or to interact with the circularity marketplace (e.g., circularity marketplace 135).

As shown, the product scanning device 200 may include a transceiver 205. The transceiver 205 may provide the product scanning device 200 with a network interface. For example, the transceiver 205 may allow the product scanning device to connect to a network (e.g., such as network 120) to access the circularity database and/or the circularity marketplace and/or to communicate with a server or other device running a machine learning model used to analyze collected data to provide circularity recommendations.

As shown, the product scanning device 200 may include one or more sensor(s) 215. The sensor(s) 215 may include sensors configured to perform any of the scanning and/or measurements described herein. For example, as shown, the sensor(s) 215 may include a camera 220 configured to image or video a product, a QR reader 235 configured to read QR codes which may be marked on a product, a microphone 225 configured to detect sounds from a product, a spectrometer 240 configured to take spectrometry measurements of a product, an RFID read 230 configured to read an RFID tag that may be marked on a product, and/or a location sensor 245 configured to collect location data about a product. The sensor(s) 215 may include additional sensors not shown configured to scan, measure, and/or collect data about a product.

As shown, the product scanning device 200 may include a processing system including one or more processor(s) 250. The one or more processor(s) 250 may comprise one or more central processing units (CPUs). The system may further include memory and/or storage, which may be local to the product scanning device 200 or remote (e.g., cloud storage). The CPU may retrieve and execute programming instructions stored in the memory. Similarly, the CPU may retrieve and store application data residing in the memory. The CPU may have multiple processing cores. The memory may represent a random access memory (RAM). The storage may be a disk drive, a combination of fixed or removable storage devices, such as fixed disc drives, removable memory cards or optical storage, network attached storage (NAS), or a storage area-network (SAN).

As shown, the one or more processor(s) 250 may include a product identification processor 255, a part identification processor 260, a material identification processor 265, a classification identification processor 270, a characteristic identification processor 275, a circularity cost identification processor 280, a circularity benefit identification processor 285, and/or a circularity protocol identification processor 290. Although shown as multiple separate processors 255-290, the processors 250 may implemented by a single processor. As described herein, one or more of the processors 250 may implement a trained machine learning model.

The product identification processor 255 may be configured to identify a product based on scanning and/or measurements of the product in accordance with techniques described herein.

The part identification processor 260, a material identification processor 265 may be configured to identify materials of a product based on scanning of the product, measurements of the product, and/or identification of the product in accordance with techniques described herein.

The classification identification processor 270, a characteristic identification processor 275 may be configured to identify one or more characteristics of a product, one or more parts of the product, and/or one or more materials of the product based on scanning of the product, based measurements of the product, and/or based identification of the product or parts in accordance with techniques described herein.

The circularity cost identification processor 280 may be configured to identify one or more costs associated with a circularity protocol for a product, one or more parts of the product, and/or one or more materials of the product in accordance with techniques described herein.

The circularity benefit identification processor 285 may be configured to identify one or more benefits associated with a circularity protocol for a product, one or more parts of the product, and/or one or more materials of the product in accordance with techniques described herein.

The circularity protocol identification processor 290 may be configured to identify one or more circularity protocols for a product, one or more parts of the product, and/or one or more materials of the product in accordance with techniques described herein.

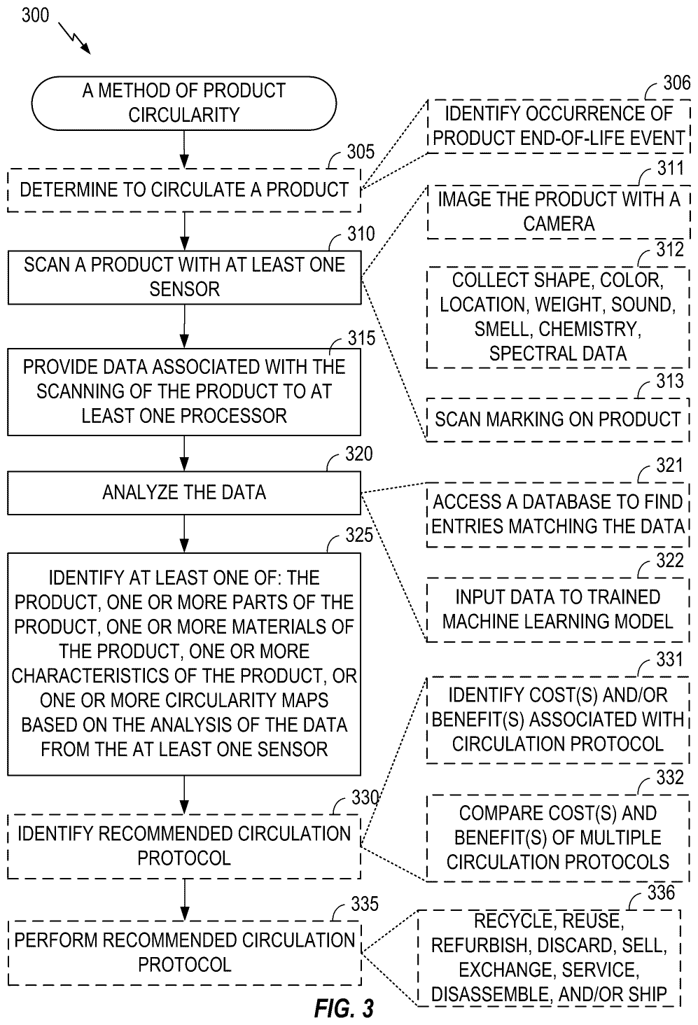

FIG. 3 depicts a flowchart of an example method 300A of product circulation. In some aspects, the method 300 may be performed by a user (e.g., user 105), by a user device (e.g., product scanning device 200), and/or by a combination of the user, the user device, and/or other devices.

At operation 305, the method 300 may optionally include determining to circulate a product. For example, the user may determine to circulate the product based on identifying, at operation 306, occurrence of a product end-of-life of the product (e.g., product 115). For example, the end-of-life may be determined when the user no longer has a use for the product, when the product breaks down, at expiry of a specified product lifetime, or upon occurrence of another end-of-life event.

At operation 310, the method 300 may include scanning the product with at least one sensor. In some aspects, the at least one sensor comprises a camera and scanning the product at operation 310 includes imaging the product with the camera at operation 311. In some aspects, scanning the product at operation 310 includes collect at least one of: shape data, color data, location data, weight data, sound data, smell data, chemistry data, or spectral measurements data of the one or more products, the one or more parts of the product, or the one or more materials of the product at operation 312. In some aspects, scanning the product at operation 310 includes scanning one or more markings on the product at operation 313.

At operation 315, the method 300 may include providing data associated with the scanning of the product to at least one processor.

At operation 320, the method 300 may include analyze the data. In some aspects, analyzing the data at operation 320 includes accessing a local or remote database (e.g., database 125) to find the entries matching the data at operation 321. In some aspects, the database contains entries with associations of data to at least one of: products, parts, materials, or characteristics of products, wherein the database is stored locally on the apparatus or is a remote database accessed by a network interface of the apparatus. In some aspects, the database includes associations for at least one of: a plurality of products, a plurality of parts, or a plurality of materials. In some aspects, the database contains associations of markings to products, parts, materials, characteristics, or circularity maps.

In some aspects, analyzing the data at operation 320 includes analyze the data using a trained machine learning model. For example, analyzing the data at operation 320 may include inputting the data to the trained machine learning model at operation 322.

In some aspects, the method includes identifying a first one of the product, one or more parts of the product, one or more materials of the product, or one or more characteristics of the product based on the analysis of the data from the at least one sensor. Analyzing the data at operation 320 may include using the first one of the product, one or more parts of the product, one or more materials of the product, or one or more characteristics of the product to search the database or inputting the first one of the product, one or more parts of the product, one or more materials of the product, or one or more characteristics of the product to the machine learning algorithm.

At operation 325, the method 300 may include identifying at least one of: the product, one or more parts of the product, one or more materials of the product, one or more characteristics of the product, or one or more circularity maps based on the analysis of the data from the at least one sensor. In some aspects, the identifying at operation 325 may be based on finding a matching entry in the database. In some aspects, the identifying at operation 325 may be based on the output of the trained machine learning model. In some aspects, the identifying at operation 325 includes first identifying a first one of the product, one or more parts of the product, one or more materials of the product, or one or more characteristics of the product based on the collected data from the at least one sensor and then the identifying at operation 325 includes identifying the at least one of: the product, one or more parts of the product, one or more materials of the product, one or more characteristics of the product, or one or more circularity maps based on first identification.

In some aspects, the identifying at operation 325 includes identifying one or more circularity maps. As mentioned above, the identifying the circularity map may be directly based on the collected data (e.g., using the database to find an entry matching the data to an associated circularity map, or inputting the data to the trained machine learning model to output an associated circularity map) or based on one or more preceding identifications (e.g., first identifying the product, and/or a part of the product, and/or a material of the product, and/or a characteristic of the product, which in turn may be based on another preceding identification such as identifying the product based on identifying one or more characteristics, identifying the one or more parts based on the identification of the product, and/or identifying the one or more materials based on identification of the one or more parts-and where any of the identifications may be based on a database or a trained machine learning model). In some aspects, the circularity map includes at least one of: a listing of parts of a product; a listing of component materials of a part or product; a quantity of the component materials; instructions for disassembling the product or part; a listing of tools for circulating the product, part, or material; and/or a circularity protocol for the product, part, and/or material. The circularity protocol may include at least one of: disassembling, refurbishing, recycling, reusing, selling, discarding, or recovering component materials or at least one of contact or shipping information for a third party (e.g., service) to perform the circularity protocol (e.g., to service the product, part, or material).

At operation 330, the method 300 may include identifying a recommended circulation protocol. In some aspects, identifying the recommended circulation protocol at operation 330 includes determine circularity cost(s) and benefit(s) associated with the identified at least one of: the product, one or more parts of the product, one or more materials of the product, one or more characteristics of the product, or one or more circularity maps at operation 331. In some aspects, the one or more circularity benefits includes at least one of a carbon footprint reduction or a market value benefit. In some aspects, identifying the recommended circulation protocol at operation 330 includes comparing (e.g., weighting and then comparing) at least one of: the one or more costs or the one or more benefits associated with a plurality of circularity protocols at operation 332. In some aspects, the method 300 includes outputting the recommended one or more circularity protocols to a user.

At operation 335, the method 300 may include performing the recommended circulation protocol. In some aspects, performing the recommended circulation protocol at operation 335 includes communicating with a circularity marketplace (e.g., circularity marketplace 135) to at least one of: sell, exchange, service, or dispose of the at least one of: the product, one or more parts of the product, or one or more materials of the product at operation 336 in response to a selection of the recommended circularity protocol at operation 330.

Aspects of the present disclosure provide systems, apparatus, and methods for product circularity.

### Example Aspects

Implementation examples are described in the following numbered aspects:

Aspect 1: An apparatus for circulating a product, the apparatus comprising: at least one sensor configured to: scan a product; and provide data associated with the scanning of the product to at least one processor; and the at least one processor, wherein the at least one processor is configured to: analyze the data; and identify at least one of: the product, one or more parts of the product, one or more materials of the product, one or more characteristics of the product, or one or more circularity maps based on the analysis of the data from the at least one sensor.

Aspect 2: The apparatus of Aspect 1, wherein: the at least one sensor comprises a camera; the camera is configured to scan the product by imaging the product; and the at least one processor is configured to identify the at least one of: the product, one or more parts of the product, one or more materials of the product, one or more characteristics of the product, or one or more circularity maps based on the imaging.

Aspect 3: The apparatus of any combination of Aspects 1-2, wherein the at least one sensor is configured scan the product to collect at least one of: shape data, color data, location data, weight data, sound data, smell data, chemistry data, or spectral measurements data of the one or more products, the one or more parts of the product, or the one or more materials of the product.

Aspect 4: The apparatus of any combination of Aspects 1-3, wherein the at least one processor is configured to: analyze the data by checking a database containing associations of data to at least one of: products, parts, materials, or characteristics of products, wherein the database is stored locally on the apparatus or is a remote database accessed by a network interface of the apparatus; and identify the at least one of the product, one or more parts of the product, one or more materials of the product, one or more characteristics of the product, or one or more circularity maps mapped to the data, provided by the at least one sensor, in the database.

Aspect 5: The apparatus of Aspect 4, wherein the database includes associations for at least one of: a plurality of products, a plurality of parts, or a plurality of materials.

Aspect 6: The apparatus of any combination of Aspects 1-5, wherein: the at least one sensor is configured scan one or more markings on the product; the at least one processor is configured to: analyze the data by checking a database, wherein the database contains associations of markings to products, parts, materials, characteristics, or circularity maps; and identify the at least one of the products, parts, materials, characteristics of products, or circularity mapped to the data, provided by the at least one sensor, in the database.

Aspect 7: The apparatus of any combination of Aspects 1-6, wherein the at least one processor is configured to: analyze the data using a trained machine learning model; and identify, based on inputting the data to the trained machine learning model, the at least one of: the product, one or more parts of the product, one or more materials of the product, one or more characteristics of the product, or one or more circularity maps.

Aspect 8: The apparatus of any combination of Aspects 1-7, wherein the at least one processor is configured to identify the product based on the analysis of the data from the at least one sensor.

Aspect 9: The apparatus of any combination of Aspects 1-8, wherein the at least one processor is configured to identify the one or more parts of the product based on the analysis of the data from the at least one sensor.

Aspect 10: The apparatus of any combination of Aspects 1-9, wherein the at least one processor is configured to identify the one or more materials of the product based on the analysis of the data from the at least one sensor.

Aspect 11: The apparatus of any combination of Aspects 1-10, wherein the at least one processor is configured to identify the one or more characteristics of the product based on the analysis of the data from the at least one sensor.

Aspect 12: The apparatus of any combination of Aspects 1-11, wherein the at least one processor is configured to identify the one or more circularity maps based on the analysis of the data from the at least one sensor, and wherein the circularity map comprises at least one of: a listing of parts of a product; a listing of component materials of a part or product; a quantity of the component materials; instructions for disassembling the product or part; a listing of tools for circulating the product, part, or material; or a circularity protocol for the product, part, or material.

Aspect 13: The apparatus of Aspect 12, wherein the circularity protocol comprises at least one of: disassembling, refurbishing, recycling, reusing, selling, discarding, or recovering component materials or at least one of contact or shipping information for a third party to perform the circularity protocol.

Aspect 14: The apparatus of any combination of Aspects 12-13, further comprising a network interface configured to communicate with a circularity marketplace to at least one of: sell, exchange, service, or dispose of the at least one of: the product, one or more parts of the product, or one or more materials of the product in response to a selection of a circularity protocol.

Aspect 15: The apparatus of any combination of Aspects 12-14, wherein the at least one processor is further configured to: weight at least one of: one or more costs or one or more benefits associated with a plurality of circularity protocols; and output a recommended one or more circularity protocols to a user.

Aspect 16: The apparatus of claim 1, wherein the at least one processor is configured to: identify a first one of the product, one or more parts of the product, one or more materials of the product, or one or more characteristics of the product based on the analysis of the data from the at least one sensor; and identify a second one or more of the product, one or more parts of the product, one or more materials of the product, one or more characteristics of the product, or one or more circularity maps based on the first identification.

Aspect 17: The apparatus of any combination of Aspects 1-16, wherein the at least one processor is further configured to determine a circularity cost associated with the identified at least one of: the product, one or more parts of the product, one or more materials of the product, one or more characteristics of the product, or one or more circularity maps.

Aspect 18: The apparatus of any combination of Aspects 1-17, wherein the at least one processor is further configured to determine a circularity benefit associated with the identified at least one of: the product, one or more parts of the product, one or more materials of the product, one or more characteristics of the product, or one or more circularity maps, and wherein the circularity benefit comprises at least one of a carbon footprint reduction or a market value benefit.

Aspect 19: A method for performing any of the operations of the apparatus of Aspects 1-18.

Aspect 20: A system for product circularity including the apparatus of Aspects 1-18.

It is contemplated that any one or more elements or features of any one disclosed embodiment or example may be beneficially incorporated in any one or more other non-mutually exclusive embodiments or examples. While the foregoing is directed to embodiments of the present disclosure, other and further embodiments of the disclosure may be devised without departing from the basic scope thereof, and the scope thereof is determined by the claims that follow.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus configured to be hand-held, the apparatus comprising:
one or more sensors configured to:
scan a product to at least one processor, wherein the one or more sensors include a camera configured to image the product to collect and provide image data including at least one of: shape data of the product or color data of the product;
the at least one processor, wherein the at least one processor is configured to:
identify and classify, using a trained machine learning model, at least one of: the product, one or more parts of the product, one or more materials of the product, or one or more characteristics of the product based on the data from the one or more sensors using a circularity database containing associations of circularity maps wherein each respective circularity map includes a circularity protocol;
determine and assign circularity points based on circularity cost, carbon footprint, market value associated with the circularity protocol, and bids within a circularity marketplace, the circularity points as a basis to estimate the cost and benefit of the circularity protocol for the product, the one or more parts of the product, the one or more materials of the product, the one or more characteristics of the product or a combination of these; and
a user interface configured to display the respective circularity maps, the circularity marketplace.

2. (canceled)

3. The apparatus of claim 1, wherein;
the one or more sensors further includes at least one of: a microphone, a spectrometer, or a location sensor; and
the data associated with the scanning of the product further includes at least one of: location data, weight data, sound data, smell data, chemistry data, or spectral data of the product, the one or more parts of the product, or the one or more materials of the product.

4. The apparatus of claim 1, further comprising at least one of: a memory or a network interface, wherein the circularity database is stored locally in the memory the apparatus or is a remote database accessed via the network interface of the apparatus.

5. The apparatus of claim 4, wherein the circularity database includes mapping for at least one of: a plurality of products, a plurality of parts, or a plurality of materials to the respective circularity maps.

6-7. (canceled)

8. The apparatus of claim 1, wherein the at least one processor is configured to identify, using the trained machine learning model, the product based on the data from the one or more sensors.

9. The apparatus of claim 1, wherein the at least one processor is configured to identify, using the trained machine learning model, the one or more parts of the product based on the data from the one or more sensors.

10. The apparatus of claim 1, wherein the at least one processor is configured to identify, using the trained machine learning model, the one or more materials of the product based on the analysis of the data from the one or more sensors.

11. The apparatus of claim 1, wherein the at least one processor is configured to identify, using the trained machine learning model, the one or more characteristics of the product based on the data from the one or more sensors.

12. The apparatus of claim 1, wherein each respective circularity map further comprises at least one of: a listing of the parts of a product; a listing of component materials of the product; a listing of component materials of the parts of the product; a quantity of the component materials; instructions for disassembling the product; instruction disassembling one or more of the parts of the product; a listing of tools for circulating the product a listing of tools for circulating one or more parts of the product; or a listing of tools for circulating the component materials.

13. The apparatus of claim 1, wherein the circularity protocol comprises protocol for at least one of: disassembling, refurbishing, recycling, reusing, selling, discarding, or recovering component materials for each respective product, part of the product, or material of the product.

14. The apparatus of claim 1, further comprising a network interface configured to communicate with the circularity marketplace, wherein the at least one processor is configured to access the circularity marketplace, via the network interface to list for at least one of: sale, exchange, servicing, or disposal the at least one of: the product, the one or more parts of the product, or the one or more materials of the product in response to a selection of the circularity protocol.

15. The apparatus of claim 1, wherein the at least one processor is further configured to:
weight at least one of: one or more costs or one or more benefits associated with a plurality of circularity protocols; and
output a recommended one or more circularity protocols to a user.

16. The apparatus of claim 1, wherein the at least one processor is configured to:
identify a first one of the product, the one or more parts of the product, the one or more materials of the product, the or one or more characteristics of the product based on the analysis of the data from the one or more sensors; and
identify a second one or more of the product, the one or more parts of the product, the one or more materials of the product, or the one or more characteristics of the product.

17. The apparatus of claim 15, wherein the at least one processor is further configured to determine the one or more costs based on the respective circularity maps.

18. The apparatus of claim 15, wherein the at least one processor is further configured to determine the one or more benefits based on the respective circularity maps, and wherein the one or more benefits comprises at least one of: a carbon footprint reduction or a market value benefit.

19. A method for circulating a product, the method comprising:
scanning a product with a hand-held apparatus comprising one or more sensors, wherein the one or more sensors include a camera, and wherein the scanning includes imaging the product to collect image data including at least one of: shape data of the product or color data of the product;
identifying and classifying, with a trained machine learning model at the hand-held apparatus, the, at least one of: the product, one or more parts of the product, one or more materials of the product, or one or more characteristics of the product based on data associated with the scanning of the product, including the image data using a circularity database containing respective circularity maps wherein each respective circularity map includes a respective circularity protocol;
determining and assigning circularity points based on circularity cost, carbon footprint, market value associated with the respective circularity protocol, and bids within a circularity marketplace, the circularity points as a basis to estimate a cost and benefit of the respective circularity protocol for the product, the one or more parts of the product, the one or more materials of the product, the one or more characteristics of the product or a combination of these;
displaying the respective circularity maps at user interface of the hand-held apparatus; and
executing the respective circularity protocols.

20. A system for circulating a product, the system comprising:
a circularity database containing a plurality of associations of at least one of: products, parts of products, or materials of products, to respective circularity maps, wherein each respective circularity map includes a respective circularity protocol for the product, part, or material;
a circularity marketplace comprising a plurality of listings for at least one of: selling, exchanging, purchasing, disposing of, or servicing at least one of: products, parts, or materials wherein the serving includes at least one of: recycling, refurbishing, or recovering materials; and
a handheld user device, the handheld user device comprising:
a memory;
a network interface;
one or more sensors configured to:
scan a product to at least one processor, wherein the one or more sensors include a camera configured to image the product to collect and provide image data including at least one of: shape data of the product or color data of the product; and
the at least one processor, wherein the at least one processor is configured to:
identify and classify, using a trained machine learning model, at least one of: the product, one or more parts of the product, one or more materials of the product, or one or more characteristics of the product based on the data from the one or more sensors using the circularity database; and
determine and assign circularity points based on circularity cost, carbon footprint, market value associated with the respective circularity protocol, and bids within the circularity marketplace, the circularity points as a basis to estimate a cost and benefit of the respective circularity protocol for the product, part, material, or a combination of these; and
a user interface configured to display the respective circularity maps,
wherein the at least one processor is further configured to:
select, or receive a selection via the user interface of, one or more of the respective circularity protocols; and
in response to the selected one or more of the respective circularity protocols;
access the circularity marketplace via the network interface; and
list, in the circularity marketplace, for sell, exchange, disposal, or service at least one of: the product, the one or more parts of the product, or the one or more materials of the product.

21. The method of claim 19, wherein:
the one or more sensors further includes at least one of: a microphone, a spectrometer, or a location sensor; and
the data associated with the scanning of the product further includes at least one of: location data, weight data, sound data, smell data, chemistry data, or spectral data of the product, the one or more parts of the product, or the one or more materials of the product.

22. The method of claim 19, wherein the circularity database is stored locally in a memory the handheld user device or is a remote database accessed via a network interface of the handheld user device.

23. The system of claim 20, wherein:
the one or more sensors further includes at least one of: a microphone, a spectrometer, or a location sensor; and
the data associated with the scanning of the product further includes at least one of: location data, weight data, sound data, smell data, chemistry data, or spectral data of the product, the one or more parts of the product, or the one or more materials of the product.
